(19) United States
(12) Patent Application Publication
(10) Pub. No.: US 2026/0001491 A1
(43) Pub. Date: Jan. 1, 2026

(54) VEHICLE STORAGE COMPARTMENT COVER AND MANUFACTURING METHOD THEREOF

(71) Applicants: HYUNDAI MOTOR COMPANY, SEOUL (KR); KIA CORPORATION, SEOUL (KR); NIFCO KOREA INC., ASAN-SI (KR)

(72) Inventors: Young Ju Lee, Hwaseong-si (KR); Dong Jin Park, Hwaseong-si (KR); Soo Jung Choi, Hwaseong-si (KR); Dong Hyeon Kim, Hwaseong-si (KR); Hong Sik Chang, Hwaseong-si (KR); Sung Hwan Kim, Hwaseong-si (KR); Seung Sik Han, Hwaseong-si (KR); Jong Chae Lee, Asan-si (KR); Yong Yeon Hwang, Asan-si (KR); Jin Kim, Asan-si (KR)

(73) Assignees: HYUNDAI MOTOR COMPANY, SEOUL (KR); KIA CORPORATION, SEOUL (KR); NIFCO KOREA INC., ASAN-SI (KR)

(21) Appl. No.: 18/971,681

(22) Filed: Dec. 6, 2024

(30) Foreign Application Priority Data
Jun. 27, 2024 (KR) 10-2024-0084526

(51) Int. Cl. B60R 7/04; B29C 45/14

(52) U.S. Cl. CPC B60R 7/04; B29C 45/14065; B29C 2045/14147

(57) ABSTRACT

A vehicle storage compartment cover includes a first material formed by a plurality of pieces arranged side by side with each other, a second material formed from a ductile material and located on an upper surface of the first material to connect the first material, and a covering film located on an upper surface of the second material and printed with a pattern at an upper surface thereof exposed to the outside.

### CROSS REFERENCE TO RELATED APPLICATIONS

This application claims under 35 U.S.C. § 119(a) the benefit of priority to Korean Patent Application No. 10-2024-0084526 filed on Jun. 27, 2024, the entire contents of which are incorporated herein by reference.

### BACKGROUND

### (a) Technical Field

The present disclosure relates to a vehicle storage compartment cover and a manufacturing method thereof and, more particularly, to a vehicle storage compartment cover capable of providing improved appearance by applying a film printed with various patterns, and a manufacturing method thereof.

### (b) Background Art

Generally, after a long period of time has elapsed in a vehicle, occupants are naturally thirsty and seek a beverage, so beverages are prepared before vehicle traveling, and a cup holder is provided in the center console for safe storage of a cup or bottle containing a beverage.

More preferably, the cup holder may be an open type in which the cup holder is provided in the form of a recessed groove with an open top for simply holding beverage containers therein, such as cups, cans, bottles, etc., or it may be a closed type in which a separate cover is provided, so that when in use, the cover is opened and the beverage containers are stored in the cup holder provided underneath.

The closed type cup holder generally has a flexible (bellows type) cover or a solid (lid type) cover, wherein the flexible cover is of a form in which the cover bends round and is inserted and stored in a compartment while moving backward along a rail, and the solid cover is of a form in which the cover is inserted and stored in a compartment while rotating backward.

In the close type cup holder, the flexible (bellows type) cover may be produced by a configuration forming a coating after double injection and a configuration applying a separate cover after double injection.

However, in the configuration forming the coating after double injection, problems such as peeling-off may occur due to the difference in elongation between the injected base material and the coated layer, and in the configuration applying the separate cover after double injection, since a groove-shaped structure for operation needs to be applied to the cover, foreign substance may be introduced into the interior of the groove-shaped structure, resulting in problems such as breakage during operation.

### SUMMARY

The present disclosure is directed to a vehicle storage compartment cover in which a first material for a bellows type cover is injected and a second material of thermoplastic plastic is injected between the first material and a covering film secured in a die, thereby providing an excellent cover appearance through the application of the covering film printed with various patterns, while preventing the occurrence of appearance problems of the bellows type cover during severe environmental operation at high and low temperatures, and a manufacturing method thereof.

Embodiments of the present disclosure provide a vehicle storage compartment cover including a first material formed by a plurality of pieces arranged side by side with each other, a second material formed from a ductile material and located on an upper surface of the first material to connect the first material, and a covering film located on an upper surface of the second material and printed with a pattern at an upper surface thereof exposed to the outside.

The second material may be formed by insert injection between the first material and the covering film.

The covering film may have a cutout to be fixedly secured to a second die facing a first die to which the first material is secured.

The second die may include a gate through which an injection for injection-forming the second material is supplied, and a pair of fixing pins protruding from both sides of the gate to fix the location of the cutouts.

The gate may extend toward the first die through a mounting guide hole provided in the cutout.

The first die may include an injection guide disposed to face the gate, a pair of mounting grooves receiving the fixing pins on both sides of the injection guide, and a fixing protrusion protruding from the injection guide to support the cutout.

The cutout may be removed from the covering film.

The second material may include a bend formed to bend along a predetermined curvature between the pieces of the first material.

The covering film may be a real wood film.

Embodiments of the present disclosure provide a method of manufacturing a vehicle storage compartment cover, the method including injection-forming a first material formed by injecting a plurality of pieces so that the pieces are arranged side by side with each other, fixing a covering film printed with a pattern to a second die facing a first die to which the first material is secured, and injection-forming a second material of a ductile material between the first material and the covering film.

The fixing of the covering film may include fitting a gate and a fixing pin of the second die into a cutout provided in the covering film, and supporting the covering film using a fixing protrusion provided on the first die.

The gate may extend toward the first die through a mounting guide hole provided in the cutout.

The injection-forming of the second material may include supplying an injection material for injection-forming the second material between the first material and the covering film through an injection guide disposed in the first die to face the gate.

The method may further include removing the cutout from the covering film as the second material is insert-injected so that the storage compartment cover is ejected.

In the vehicle storage compartment cover according to the present disclosure, the first material for the bellows type cover is injected and the second material of thermoplastic plastic is injected between the first material and the covering film secured in the die, thereby providing an excellent cover appearance through the application of the covering film printed with various patterns, while preventing the occurrence of appearance problems of the bellows type cover during severe environmental operation at high and low temperatures.

The present disclosure also has the effect of providing a refined and luxurious texture in appearance by applying the covering film of elastic real wood, and maintaining the original pattern of the real wood even during operation of the storage compartment cover.

### BRIEF DESCRIPTION OF THE FIGURES

FIG. 1 is a diagram illustrating a cup holder applied with a vehicle storage compartment cover according to an embodiment of the present disclosure;

FIG. 2 is a diagram illustrating the vehicle storage compartment cover according to the embodiment of the present disclosure;

FIG. 3 is a cross-sectional diagram taken along a section A-A in FIG. 2 to illustrate a structure of the vehicle storage compartment cover according to an embodiment of the present disclosure;

FIGS. 4 and 5 are diagrams illustrating the fixation of a covering film in the vehicle storage compartment cover according to an embodiment of the present disclosure;

FIGS. 6 and 7 are diagrams illustrating supporting of the covering film in the vehicle storage compartment cover according to an embodiment of the present disclosure;

FIG. 8 is a diagram illustrating a gate for the vehicle storage compartment cover according to an embodiment of the present disclosure;

FIG. 9 is a diagram illustrating the ejected state of the vehicle storage compartment cover according to an embodiment of the present disclosure; and

FIGS. 10A, 10B, 10C, 10D, and 10E are conceptual diagrams schematically illustrating a method of manufacturing the vehicle storage compartment cover according to another embodiment of the present disclosure.

### DETAILED DESCRIPTION

Preferred embodiments of the present disclosure will now be described in detail with reference to the accompanying drawings.

The advantages and features of the present disclosure, and methods of achieving them, will become apparent upon reference to embodiments described in detail in conjunction with the accompanying drawings.

However, the present disclosure is not intended to be limited by the embodiments disclosed herein, but will be embodied in many different forms. These embodiments are provided merely to make the present disclosure complete, and to give those having ordinary skill in the art to which the present disclosure belongs a complete idea of the scope of the invention, which is defined by the claims.

Furthermore, if it is believed that relevant known technologies would obscure the essence of the present disclosure in describing the present disclosure, a detailed description thereof will be omitted herein.

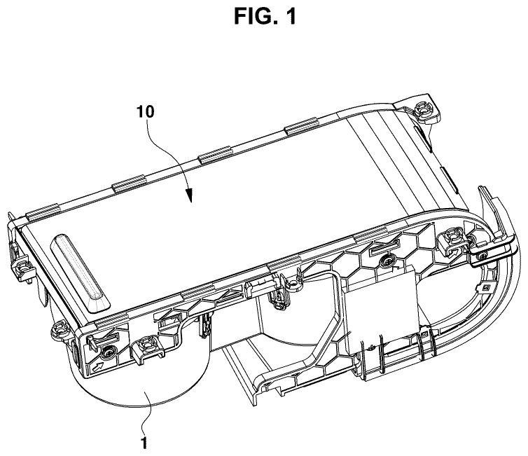

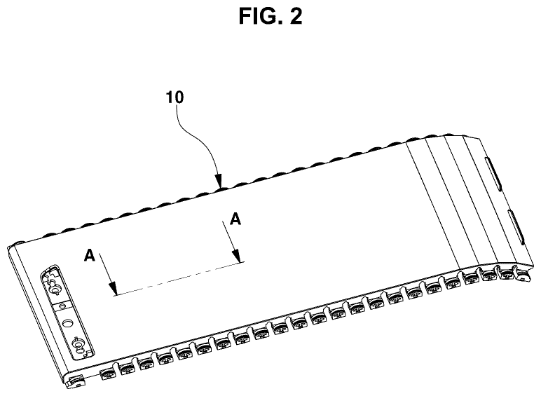

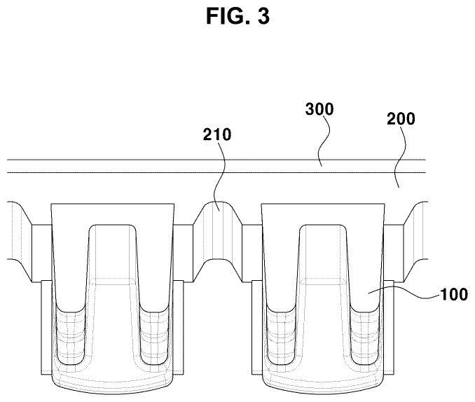

FIG. 1 is a diagram illustrating a cup holder applied with a vehicle storage compartment cover according to an embodiment of the present disclosure, FIG. 2 is a diagram illustrating the vehicle storage compartment cover according to the embodiment of the present disclosure, and FIG. 3 is a cross-sectional diagram taken along a section A-A in FIG. 2 to illustrate a structure of the vehicle storage compartment cover according to an embodiment of the present disclosure.

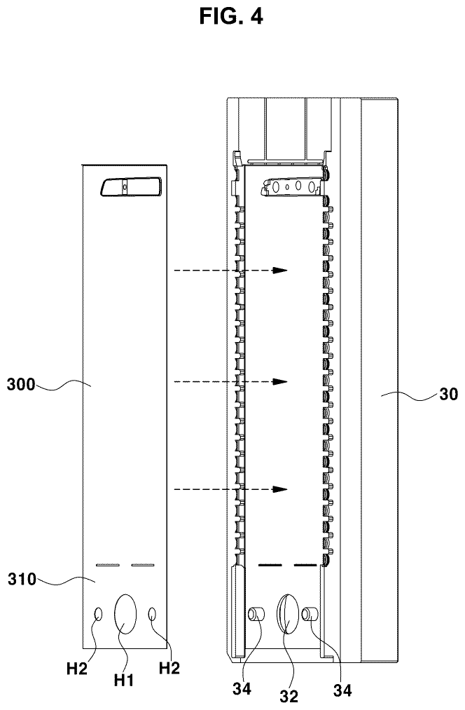

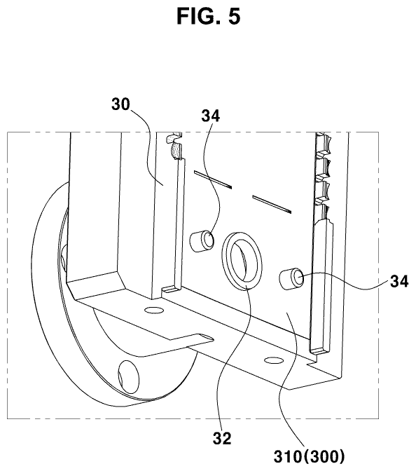

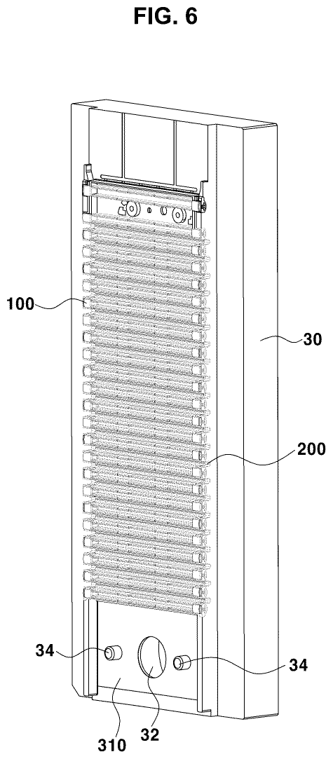

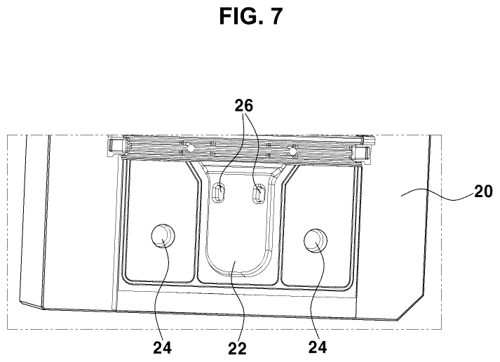

FIGS. 4 and 5 are diagrams illustrating the fixation of a covering film in the vehicle storage compartment cover according to an embodiment of the present disclosure, and FIGS. 6 and 7 are diagrams illustrating supporting of the covering film in the vehicle storage compartment cover according to an embodiment of the present disclosure.

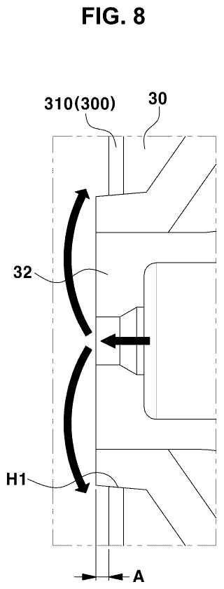

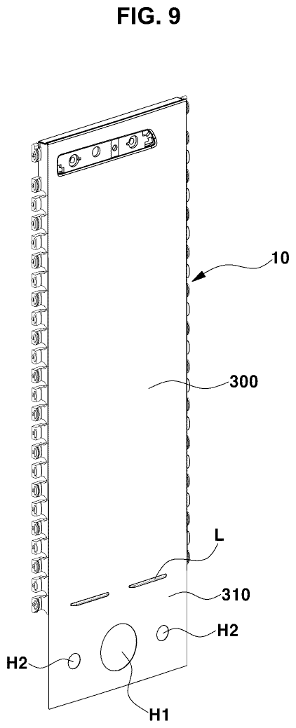

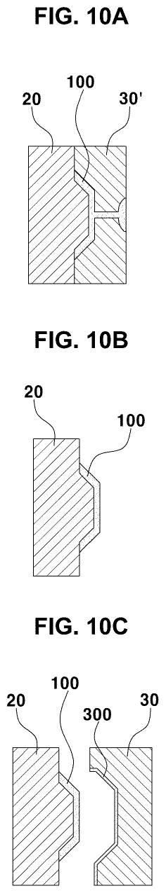

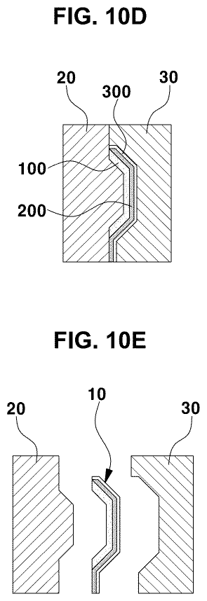

FIG. 8 is a diagram illustrating a gate for the vehicle storage compartment cover according to an embodiment of the present disclosure, FIG. 9 is a diagram illustrating the ejected state of the vehicle storage compartment cover according to an embodiment of the present disclosure, and FIGS. 10A to 10E are conceptual diagrams schematically illustrating a method of manufacturing the vehicle storage compartment cover according to another embodiment of the present disclosure.

In general, various controls and conveniences are installed on the dashboard and audio deck, gearshift, airbags, door locks and window openers, etc. mounted around the driver's and passenger's seats in the interior of a vehicle, and interior finish panels are installed in the gaps between the outer perimeter of the controls and conveniences and the interior materials to finish the interior materials, which are becoming an important factor in determining the appearance of the interior of the vehicle.

Since such vehicle interior materials have a significant impact on the aesthetics of the vehicle interior, as the design of vehicles becomes increasingly personalized, aesthetic requirements are becoming increasingly important.

As illustrated in FIG. 1, the vehicle storage compartment cover 10 according to the present embodiment, for example, a cover for shielding the open interior of a cup holder 1, is made of a bellows type structure, so that the cover may conform to the user's aesthetic needs while also responding to functional needs such as preventing foreign objects from entering the interior.

Here, the storage compartment cover 10 may include a first material 100, a second material 200, and a covering film 300, as illustrated in FIGS. 2 and 3.

The first material 100 is formed by a plurality of pieces arranged side by side with each other.

The first material 100 is intended to form the basic framework of the bellows type structure, and is rail-coupled to the interior of the cup holder 1 so as to selectively open the cup holder 1 upon slide movement (see FIG. 1).

To this end, the plurality of pieces of the first material 100 are formed to extend in the longitudinal direction with a length along the widthwise direction in order to be rail-coupled to the interior of the cup holder 1.

Preferably, the first material 100 may be injection-formed by injecting an injection between a first die 20 and a second die 30′, as illustrated in FIG. 10A. The first material may be formed of preferably, polycarbonate (PC)-acrylonitirile-butadiene-styrene (ABC) or polypropylene (PP)+T20 material, more preferably, a material that facilitates adhesion to the second material 200.

The second material 200 is formed from a ductile material and is located on top of the first material 100 to connect the plurality pieces of the first material 100, as illustrated in FIG. 3.

The second material 200 may be formed by insert injection between the first material 100 and the covering film 300 by fixing the covering film 300 to the second die 30 as illustrated in FIG. 10C, with the first material 100 secured in the first die 20 as illustrated in FIG. 10B, and in this state, injecting an injection material between the first die 20 and the second die 30, as illustrated in FIG. 10D.

Preferably, the second material 200 may be formed of any of the following ductile materials: thermoplastic elastomer (TPE), thermoplastic elastomer-styrenic (TPS) or thermoplastic olefin (TPO), but these are just one embodiment and are not limiting, and the second material may be formed of other materials with the same properties. The second material may also be formed of a material that facilitates adhesion to the covering film 300.

The second material 200 may be provided with a bend 210 to allow for smooth operation during operation of the storage compartment cover 10 having the bellows type structure.

That is, the bend 210 is formed to bend along a predetermined curvature between neighboring pieces of the first material 100 (see FIG. 3).

In other words, the bend 210 may enable the compartment cover 10 to bend a curvature during slide movement along the direction for opening the compartment cover 10, thereby enabling smooth operation for the compartment cover 10 having the bellows type structure.

On the other hand, the covering film 300 is located on the upper surface of the second material 200 (see FIG. 3), and has an exposed upper surface printed with various patterns.

The covering film 300 may be formed of a material that may ensure adhesion with the second material 200.

The exposed upper surface of the covering film 300 may have a flat structure regardless of the bellows type structure of the first material 100, thereby providing excellent appearance quality while preventing problems such as deterioration of operational performance caused by foreign substance entering the recessed upper surface of the conventional bellows type structure storage compartment cover.

In order to deal with durability problems and the above operational performance problems with the bellows type structure, the covering film 300 may be composed of a binder layer, a thermoplastic poly-urethane (TPU) based layer, a polyethylene terephthalate (PET) or acrylonitirile-butadiene-styrene (ABC) layer, a pattern printing and coating layer.

More preferably, the covering film 300 may be formed to have a light-reflective feature, so that when the first material 100 having the bellows type structure is rail-coupled to the interior of the cup holder 1, light from an illumination structure (not shown) installed in the interior of the cup holder 1 may be easily reflected by the light-reflective feature, which improves the appearance aesthetics caused by the illumination structure.

The covering film 300 may be secured to the second die 30 facing the first die 20 in which the first material 100 is secured, as illustrated in FIG. 4, wherein the covering film 300 may have a cutout 310 to be secured to the second die 30.

Specifically, as illustrated in FIG. 5, the second die 30 may include a gate 32, which is a passageway through which an injection material for injection-forming the second material 200 is fed, and a pair of fixing pins 34 protruding from both sides of the gate 32 to fix the position of the cutout 310. Thus, the cutout 310 serves to fix the position of the covering film 300 secured to the second die 30 by the gate 32 and the fixing pins 34.

To this end, the cutout 310 may be provided with a mounting guide hole H1 and through holes H2, through which the gate 32 and the fixing pins 34 are fitted and secured to restrict the movement of the covering film 300 and allow the position of the covering film to be held in place on the second die 30, thereby preventing problems such as warping of the covering film 300 due to injection pressure during injection molding of the second material 200 in advance.

Here, as illustrated in FIG. 7, when the second die 30 in which the covering film 300 is secured for injection of the second material 200 is positioned to face the first die 20 in which the first material 100 is secured (see FIG. 10D), the first die 20 supports the covering film 300 with the provision of an injection guide 22, seating grooves 24, and fixing protrusions 26, which correspond to the structure of the gate 32 and the fixing pins 34 provided in the second die 20.

That is, the injection guide 22 is disposed to face the gate 32, the seating grooves 24 are formed to accommodate the fixing pins 34 on both sides of the injection guide 22, and the fixing protrusions 26 protrude from the injection guide 22 to support the cutout 310.

Preferably, the fixing protrusions 26 protrude a predetermined height to form a space between the bottom surface of the injection guide 22 and the cutout 310 that the protrusions support (see FIG. 7), and as illustrated in FIG. 8, as the gate 32 extends toward the injection guide 22 through the mounting guide hole H1 formed in the cutout 310, the injection material supplied from the gate 32 for injection of the second material 200 may be injected into the space between the first material 100 and the cutout 310.

This is because the second material 200 is formed of one of TPE, TPS, or TPO, which, due to the nature of the material, changes to a liquid state and flows when molded, so that when injection-molding the second material 200, the injection material for injection of the second material 200 flows into the covering film 300 to cause defects, the gate 32 is formed to extend toward the injection guide 22 a protrusion length A, for example, about 2 mm, from the cutout 310 through the mounting guide hole H1 (see FIG. 8) to prevent the problem of defects occurring when the injection material supplied through the gate 32 flows into the covering film 300.

As illustrated in FIG. 9, when the storage compartment cover 10 is withdrawn from the first die 20 and the second die 30 (see FIG. 10E), the cutout 310 of the covering film 300 may be removed from the covering film 300 along the shear line L, By doing so, it is possible to complete the storage compartment cover 10 having a structure in which the covering film 300 is combined with the double injection structure of the first material 100 and the second material 200 (see FIG. 3), thereby providing a storage compartment cover 10 capable of providing an appearance printed with various patterns, while preventing appearance problems from occurring during severe environmental operation of the bellows type structure.

On the other hand, the covering film 300 may be formed from a real wood film.

While in a conventional bellows type structure, the application of a real wood material is bound to cause problems such as surface bursting and cracking due to the limitation of flexibility by the inherent characteristics of wood, in this embodiment, the real wood covering film 300 may be located on top of a crack-resistance structure layer formed by sequentially laminating non-woven fabric, TPU, non-woven fabric, and TPU to provide a refined and luxurious texture in appearance through the application of the stretchable covering film 300, while maintaining the original pattern of the real wood during operation of the bellows type structure.

Furthermore, in this embodiment, the upper surface of the covering film 300 of the real wood may be coated with a UV-resistant coating layer and a polyurethane (PU) coating layer to prevent appearance scratches and discoloration.

In the vehicle storage compartment cover according to the present disclosure, the first material for the bellows type cover is injected and the second material of thermoplastic plastic is injected between the first material and the covering film secured in the die, thereby providing an excellent cover appearance through the application of the covering film printed with various patterns, while preventing the occurrence of appearance problems of the bellows type cover during severe environmental operation at high and low temperatures.

The present disclosure also has the effect of providing a refined and luxurious texture in appearance by applying the covering film of elastic real wood, and maintaining the original pattern of the real wood even during operation of the storage compartment cover.

While the present disclosure has been described with reference to the embodiment(s) illustrated in the drawings, these are merely illustrative, and those having ordinary knowledge in the art will understand that various modifications may be made therefrom, and that all or any part of the above-described embodiment(s) may be optionally combined. Therefore, the true technical scope of the present disclosure should be defined by the technical ideas of the appended claims.

1. A vehicle storage compartment cover comprising:
a first material formed by a plurality of pieces arranged side by side;
a second material formed from a ductile material and located on an upper surface of the first material to connect the second material to the first material; and
a covering film located on an upper surface of the second material, the covering film being printed with a pattern at an upper surface exposed to an outside.

2. The vehicle storage compartment cover of claim 1, wherein the second material is formed by insert injection between the first material and the covering film.

3. The vehicle storage compartment cover of claim 1, wherein the covering film has a cutout configured to be fixedly secured to a second die facing a first die to which the first material is secured.

4. The vehicle storage compartment cover of claim 3, wherein the second die includes:
a gate through which an injection for injection-forming the second material is supplied, the gate having a first side and a second side; and
a first fixing pin protruding from the first side of the gate and a second fixing pin protruding from the second side of the gate to fix a location of the cutout.

5. The vehicle storage compartment cover of claim 4, wherein the gate extends toward the first die through a mounting guide hole positioned in the cutout.

6. The vehicle storage compartment cover of claim 4, wherein the first die includes:
an injection guide positioned to face the gate, the injection guide having a first side and a second side;
a first mounting groove configured to receive the first fixing pin on the first side of the injection guide, and a second mounting groove configured to receive the second fixing pin on the second side of the injection guide; and
a fixing protrusion protruding from the injection guide to support the cutout.

7. The vehicle storage compartment cover of claim 3, wherein the cutout is removed from the covering film.

8. The vehicle storage compartment cover of claim 1, wherein the second material includes a bend formed to bend along a predetermined curvature between the plurality of pieces of the first material.

9. The vehicle storage compartment cover of claim 1, wherein the covering film is a wood film.

10. A method of manufacturing a vehicle storage compartment cover, the method comprising:
injection-forming a first material by injecting a plurality of pieces s arranged side by side;
fixing a covering film printed with a pattern to a second die facing a first die to which the first material is secured; and
injection-forming a second material by injecting a ductile material between the first material and the covering film.

11. The method of claim 10, wherein fixing the covering film comprises:
fitting a gate and a fixing pin of the second die into a cutout provided in the covering film; and
supporting the covering film using a fixing protrusion provided on the first die.

12. The method of claim 11, wherein the gate extends toward the first die through a mounting guide hole provided in the cutout.

13. The method of claim 11, wherein injection-forming the second material comprises:
supplying an injection material for injection-forming the second material between the first material and the covering film through an injection guide disposed in the first die to face the gate.

14. The method of claim 11, further comprising removing the cutout from the covering film as the second material is insert-injected to eject the storage compartment cover.
